(19) United States
(12) Patent Application Publication
(10) Pub. No.: US 2005/0287347 A1
(43) Pub. Date: Dec. 29, 2005

(54) Polyurethane and rigid substrate composite with fasteners

(75) Inventor: Vincent Sorrentino, Poinciana, FL (US)

Correspondence Address: LOTT & FRIEDLAND, P.A., P.O. BOX 141098, CORAL GABLES, FL, 33114-1098, US

(73) Assignee: Pavilion Furniture, Inc.

(21) Appl. No.: 11/215,659

(22) Filed: Aug. 29, 2005

Related U.S. Application Data
(63) Continuation-in-part of application No. 10/452,259, filed on Jun. 2, 2003.

(51) Int. Cl. B32B 3/26

(52) U.S. Cl. 428/304.4; 428/318.4

(57) ABSTRACT

A polyurethane and rigid substrate composite that can be used in the construction of outdoor furniture. The composite further includes fasteners which securely attach the substrate core to the furniture frame.

### CLAIM OF PRIORITY

This application is a continuation in part of U.S. application Ser. No. 10/452,259, filed on Jun. 2, 2003, the contents of which are incorporated herein by reference.

### FIELD OF INVENTION

The present invention relates generally to the field of materials engineering, and more particularly, to a polyurethane and rigid substrate composite that can be used in the construction of outdoor furniture. The composite further includes fastener pins which securely attach the substrate core to a furniture frame.

### BACKGROUND OF THE INVENTION

New furniture is always in demand by consumers in the United States and abroad. Today's economy has created a particularly hospitable environment for furniture manufacturers. Low interest rates have stimulated new housing starts and sales. New-home sales for August of this year were pegged at 996,000, up 1.9% from July and 14.4% from August of last year. New-home sales have trended up throughout the past year, and August's number was up 16.4% from the 13-month low of 856,000 in September 2001. New housing typically translates to higher sales numbers for the furniture industry. If furniture spending continues at the present pace, it will finish the year at $66.8 billion, up sharply from 2001's $64 billion. http://www.furnituretoday.com/news/news10-14-02d.shtml.

A sub-segment of the consumer furniture industry is outdoor furniture. Outdoor furniture sales continue to rise with the overall trends. Although outdoor furniture can be constructed of various materials, weather resistant materials are obviously more favorable. One such material is polyurethane. Introduced commercially in 1954, urethanes have made an impact on a broad spectrum of U.S. industry. They are extremely versatile plastics in terms of the forms in which they are available: flexible or rigid foams, solid elastomers (or rubbers), coatings, adhesives and sealants. Their versatility also extends to chemical structure in that, although the urethanes are generally considered to be thermosets, there are grades of urethane elastomers that are thermoplastic in nature and are supplied in pellet form for molding, calendering and extrusion. Polyurethane's major and best known form, however, is a foamed or “cellular” material.

Like all urethanes, the foams are prepared by first reacting two liquid components—polyols and isocyanates—together. In the presence is of a blowing agent, this reaction will produce a foamed material having excellent thermal insulating properties, and, in fact, polyurethane foam is widely used in building insulation. The foams can either be soft and flexible or tough, and rigid, with all the possible variations in-between. Flexible foams have outstanding cushioning characteristics, excellent energy-absorbing properties and long life. They are used in furniture, cushioning, carpet underlay, bedding, packaging, textiles and automotive seating and safety padding. Rigid foams offer outstanding insulating values, excellent compressive strength, good dimensional stability and buoyancy. Besides building insulation, they are also found in refrigerators, trucks, boats (for flotation), and in the construction of furniture components.

As coatings, polyurethanes impart excellent protective and decorative effects to wood, metals, rubber, textiles, concrete, paper, leather, other plastics and many other materials. In the form of elastomers, polyurethanes offer superior abrasion resistance and toughness, and are used in applications in which good performance and long service life are important: printing rolls, gaskets and seals, cable insulation, drive and conveyor belts, solid tires and automotive applications. http.//www.socplas. org/industry/defs. htm.

Previous attempts have been made to provide polyurethane foam structures for possible use with furniture, such as described in U.S. Pat. No. 6,482,875 to Lorenz, et al ('875 patent); U.S. Pat. No. 6,481,476 to Okamoto ('476 patent); U.S. Pat. No. 5,173,990 to Owen ('990 patent); U.S. Pat. No. 5,037,860 to Parrish, et al. ('860 patent); and U.S. Pat. No. 4,714,574 to Tenhagen ('574 patent); all of which are incorporated herein by reference.

The '875 patent describes a thermoplastic composite material containing at least 15 percent by weight of one or more organic fibrous material, and at least 15 percent by weight of thermoplastic binder, with binder containing at least two different polyacrylates. The thermoplastic composite material has a flow transition range of 70 degrees C. to 130 degrees C. The invention also relates to a method for producing the thermoplastic composite material and the use of the thermoplastic composite material to coat the surfaces of objects. The '875 does not provide a wood-like appearance for the thermoplastic composite material, rather, it incorporates natural fibers such as wood in order to make the material more suited for its purpose.

The '476 patent describes a method of manufacturing an artificially figured veneer or artificially figured board at high productivity with the expression of the grain and figure of natural wood in very similar form observed in natural woods, in addition to normal grain of natural wood. The invention of the 476' patent relates to the method of manufacturing an artificially figured veneer or an artificially figured board, comprising the steps of 1) preparing a set of a multiple sheets of material veneers by rotary cutting a log or repeatedly cutting a wood flitch with their grains sequential, 2) embossing simultaneously said material veneers whose number was determined according to the static bending strength (proportional limit) and specific gravity of the material veneers, with press dies having concave-convex patterns corresponding to a site of figure of a natural wood, to form a concave-convex pattern on the material veneers, 3) laminating the set of embossed material veneers such that their grains become substantially sequential, and pressing it with said press dies, and 4) cutting the laminate in the direction crossing the plane of the lamination to manufacture an artificially figured veneer or an artificially figured board with desired thickness. While the '476 patent is directed towards providing an artificial material that appears like wood, it is used merely as a veneer and not as a weight bearing member as would be used in furniture, for example.

The '990 patent describes a furniture, or bed support and caster protector device, consisting of a sleeve or cylindrical body constructed of a generally resilient material having a hollow center and adapted to circumvallate the bed support and the supporting caster thereof, a radially disposed cut in the sleeve extending along at least one radius thereof to provide accessing of the sleeve around the bed support and caster, and also to facilitate its removal therefrom, and the sleeve having a longitudinal dimension being slightly grater in distance than is an overall distance between a bed rail, disposed at an upper extremity of the bed support, and a support plane or floor for support of the caster, to effect a slight compression of the sleeve due to its resilient characterization and tending to retain the sleeve in locus between the bed rail and the support plane or floor; the sleeve has a lower section with a larger diameter at the lower section and has an upper section with a smaller diameter to provide more distribution of the slight compression within the upper section than in the lower section. This relates more particularly to a quickly applied cushioning cover for bed supports, and casters, to prevent accidental injury to the feet, ankles and shins of the person coming into accidental contact with the bed. The material of the sleeve is of a sponge material, an elastomeric material, an expanded polyurethane material, a foam material, a resinous material, or an open cell material that is removably available for washing and sanitizing the device. While the '990 patent provides a product that utilizes polyurethane, it does not appear like wood, and is not used for the same purpose as the present invention.

The '860 patent describes flexible foam prepared using 1,1,1-trichloroethane as the sole or predominant auxiliary blowing agent. The '860 patent describes a polyurethane product that uses an ethane based blowing agent, however the primary purpose of the '860 is to provide 1,1,1-trichloroethane as a blowing agent, not to provide a material that has a natural appearance for use in outdoor furniture.

The '574 patent describes a flexible polyurethane foam article with regions of different hardness made by introducing into a mould a foam formulation giving a foam of a given hardness and then introducing a foam formulation giving a foam of different hardness directly onto the first foam formulation at a time corresponding to a volume expansion in the range 100% to 2300%. The '574 patent describes polyurethane foam for use with seats, however, it provides for foam cushions exhibiting different levels hardness throughout the structure. In addition, there are no provisions for making it appear natural for use with outdoor furniture.

Consequently, there is a need in the art for a polyurethane foam product, made with pentane as a blowing agent, that is adapted to look like a naturally occurring substance, such as wood, and can be used in the construction of outdoor furniture. There is a further need in the art for there is a need in the art for a polyurethane foam product that is adapted to look like a naturally occurring substance, such as wood, used in conjunction with a rigid substrate core and fastener pins and which can be used in the construction of outdoor furniture.

### SUMMARY OF THE INVENTION

The present invention solves significant problems in the art by providing a composite product that can be used in the manufacture of outdoor furniture that is weather resistant, inexpensive to make and provides an attractive appearance to the furniture.

A preferred embodiment of the invention provides a composite product for use in manufacturing outdoor furniture, comprising a substrate core material, polyurethane foam, and at least one fastener pin, whereby the foam fully encapsulates the substrate core and provides a wood grain appearance, wherein the substrate core material is centrally positioned in the polyurethane foam, and wherein at least one fastener pin securely attaches the substrate core to a furniture frame.

In an alternative embodiment, the invention provides an article of furniture manufactured using a composite product comprising a substrate core, polyurethane foam, and at least one fastener pin, whereby the foam fully encapsulates the substrate core and provides a wood grain appearance, wherein the substrate core is centrally positioned in the foam, and wherein at least one fastener pin securely attaches the substrate core to a furniture frame.

In a further alternative embodiment, the invention provides a composite product, made with pentane as a blowing agent, for use in manufacturing outdoor furniture, comprising a substrate core, whereby the substrate core is made of steel; polyurethane foam, whereby the foam fully encapsulates the substrate core and provides a wood grain appearance, wherein the substrate core is centrally positioned in the polyurethane foam; and at least one fastener pin composed of a semi-rigid material, wherein the at least one fastener pin attaches the substrate core to a furniture frame.

Accordingly, it is an object of the present invention to provide a polyurethane foam product, made with pentane as a blowing agent, that is adapted to look like a naturally occurring substance, such as wood, and can be used in the construction of outdoor furniture.

It is another object of the present invention to provide a polyurethane foam product that is adapted to look like a naturally occurring substance, such as wood, used in conjunction with a rigid substrate core and fastener pins and which can be used in the construction of outdoor furniture.

These and other objects, features and advantages of the present invention may be better understood and appreciated from the following detailed description of the embodiments thereof, selected for purposes of illustration and shown in the accompanying drawings.

### BRIEF DESCRIPTION OF THE DRAWINGS

FIG. 1 is a perspective, cross-sectional view of a preferred embodiment of the invention.

FIG. 2 is a perspective view of the rigid substrate in a preferred embodiment of the present invention.

FIG. 3 is a top or bottom view of a preferred embodiment of the invention.

FIG. 4 is a side view of a preferred embodiment of the invention.

FIG. 5 is an end view of a preferred embodiment of the invention.

FIG. 6 is an illustration of the invention being used for outdoor furniture.

FIG. 7 is a cross-sectional view of the composite and fastener pin.

FIG. 8 is a side view of a fastener pin.

### DETAILED DESCRIPTION OF THE PREFERRED EMBODIMENT

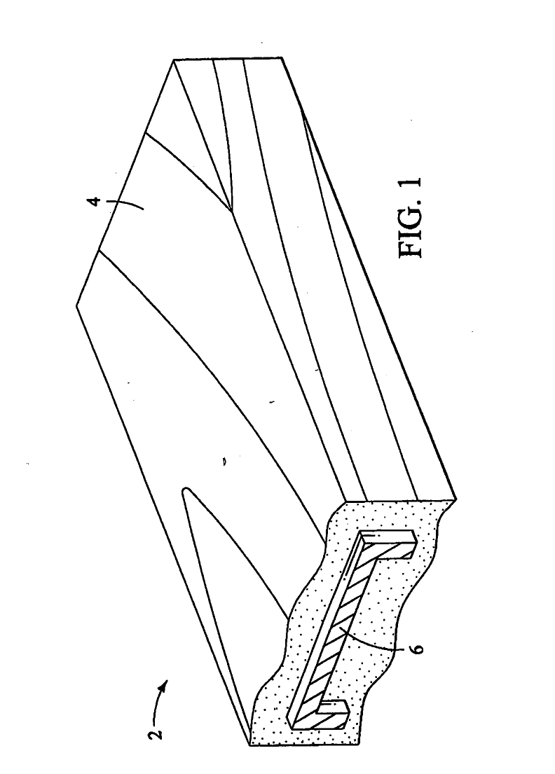

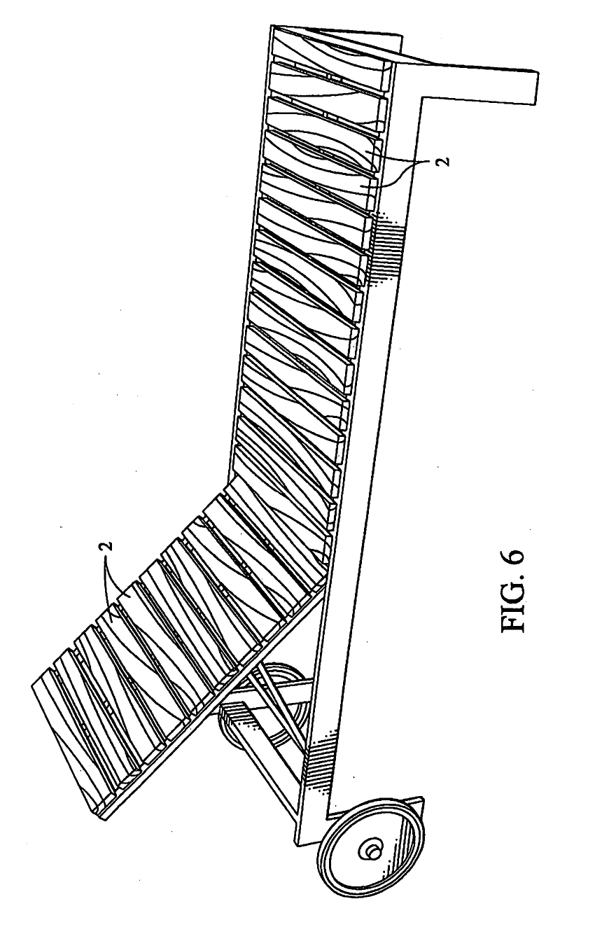

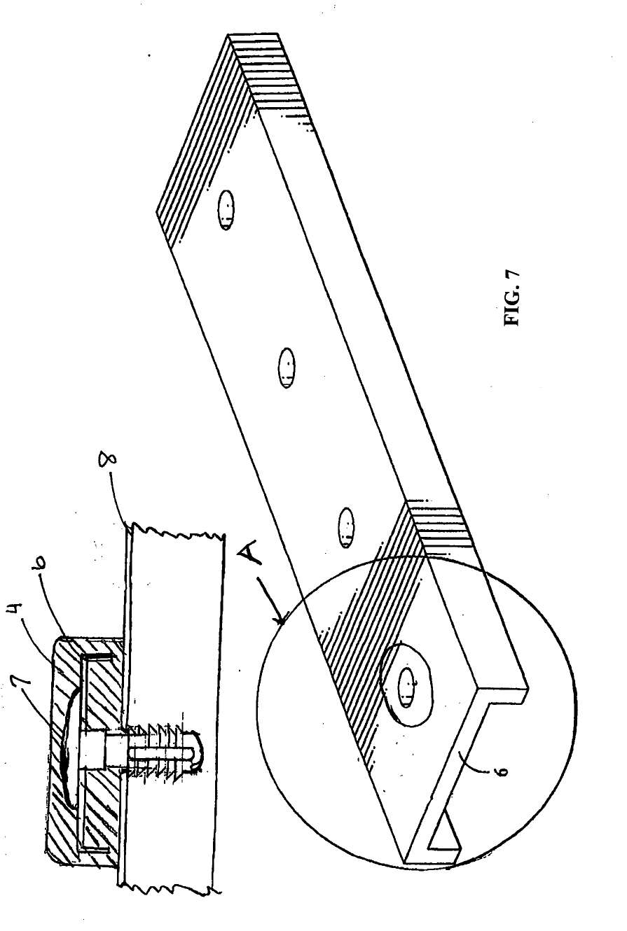

Referring initially to FIG. 1 of the drawings, in which like numerals indicate like elements throughout the several views, in a preferred embodiment a perspective, cross-section of the invention can be seen. The composite product 2 is comprised of outer polyurethane foam 4 and a substrate core 6, such as steel, for supplying extra rigidity to the overall product 2. While steel is discussed herein, the substrate core 6 can be any material that provides additional rigidity to the polyurethane foam, for example, wood, metals other than steel, stone or composite materials. The substrate core 6 is preferably centrally positioned in the polyurethane foam 4. When steel is used for the substrate core 6, it is preferably 14-16 gage steel. The extra rigidity allows the product 2 to be used for weight bearing applications, such as furniture, see FIG. 6. An additional advantage of using the rigid substrate core 6 is that it allows for product to be fastened to the frame in virtually any configuration. As shown in FIG. 7, additional support may be provided by a fastener pin 7 that attaches the rigid substrate core 6 to a heavy gage furniture frame 8 without the need for center supports. To provide for maximum life of the product 2, the rigid substrate core 6 is completely enclosed in the polyurethane foam 4. Centrally encased in the polyurethane 4, the substrate core 6 is protected from the weather. Center supports can be used behind the product 2 if unusually large amounts of force are expected.

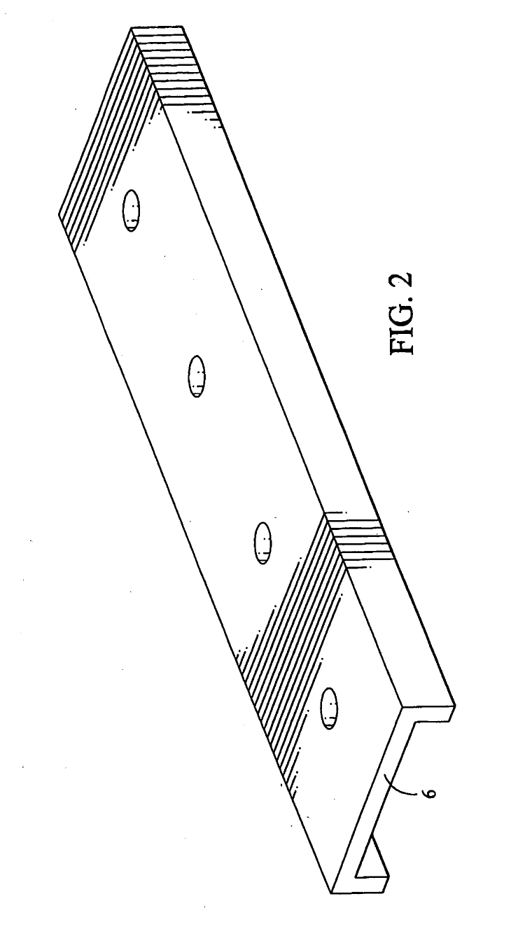

As illustrated in FIG. 2, the substrate core 6 is vented in a preferred embodiment of the present invention. The venting allows for the polyurethane foam 4 to become intertwined with the substrate core 6 in order to form a more secure bond between the two components during manufacturing. The holes also facilitate polyurethane 4 flow around the substrate core 6 during manufacturing. Although not a requirement, this configuration is preferred to a non-vented substrate core 6. The substrate core 6 also preferably contains a “U shaped” configuration such that the underside of the substrate core 6 forms a channel. The channel of the substrate core 6 further facilitates polyurethane 4 flow around the substrate core 6 and enhances the strength of the final composite product 2.

During the manufacturing of the product 2, a volatile organic substance such as pentane should be used as the blowing agent. Water is often used in the manufacture of polyurethane foams; however it provides a less weather resistant foam so it should not be used for the purpose of making outdoor furniture. There are two general types of urethane processing machines, high pressure and low pressure. High pressure machines use high pressure impingement mixing, that is, the two streams come together at high pressure in the mix head before the material is dispensed into the mold. A low pressure machine uses a dynamic mix head (spinning mixer) to intimately mix the two components in the mix chamber before the material is dispensed into the mold. In the preferred embodiment of the present invention, the low pressure machine is used to combine the urethane foam material and the pentane blowing agent.

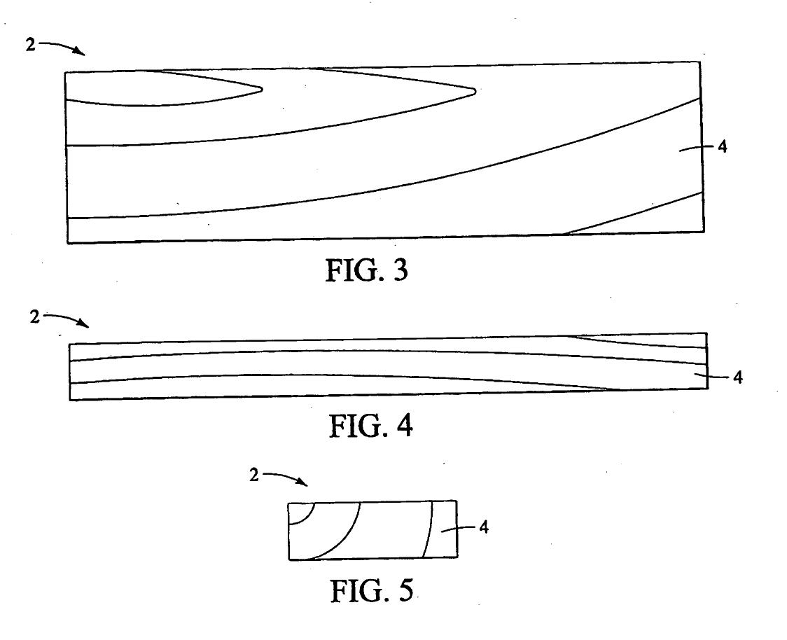

FIGS. 3-5 show varying views of the invention and the natural wood-like appearance. FIG. 3 is a top or bottom view, FIG. 4 illustrates the side, and FIG. 5 is representative of the end view. It is important to note that the wood grain depicted in the Figures is merely is representative of the type of wood grain the invention can portray. As with nature, the artificial wood grain can take on almost infinite variation and still appear to be natural wood. The mold used to create the polyurethane foam 4 primarily dictates the grain.

Turning to FIG. 6, an illustration of the invention being used for outdoor furniture is depicted. The article of furniture is a typical lawn chair with an adjustable backrest capable of inclining (to the sitting upright position) or declining (to the laying down position). Slats of the present invention are used for the seat material. The product 2 is attached to the furniture frame 8 by an adhesive and fastener pins 7 in the preferred embodiment.

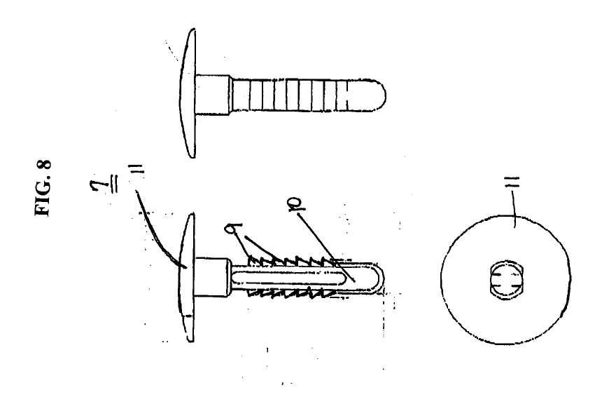

As shown in FIG. 7 and FIG. 8, a fastener pin 7 is preferably used to fasten the substrate core 6 to a furniture frame 8. The fastener pin 7 is a semi-rigid pin and can be formed of a plastic material or other suitable material. The design of the fastener pin 7 allows it to anchor the slat 2 to a heavy gage furniture frame 8. The fastener pin 7 is put through the substrate core 6 prior to the polyurethane foam 4 being molded over the substrate core 6. The fastener pin 7 is placed in a hole in the substrate core 6 similar to a vent hole; however, the fastener pin 7 is placed in a hole called the location hole. Location holes are placed in particular locations though the substrate core 6 such that the fastener pin 7 is aligned to go through the substrate core 6 and into the furniture frame 8. When these location holes interfere with the location of the vent hole, the vent hole is relocated so that it retains its original design and function, but does not interfere with the location hole and the placement of the fastener pin 7 into the furniture frame 8.

As shown in FIG. 8, the fastener pin 7 contains a round, flat head 11, a stem 10 and ridges 9 on the stem. This type of fastener pin 7 is commonly referred to as a Christmas tree screw. The ridges 9 assist in securing the fastener pin 7 in place. When the fastener pin 7 is screwed into place, the ridges 9 will lay underneath the first side of the furniture frame 8 on which the composite is attached and prevent the fastener pin 7 from lifting out of the furniture frame 8.

Accordingly, it will be understood that the preferred embodiment of the present invention has been disclosed by way of example and that other modifications and alterations may occur to those skilled in the art without departing from the scope and spirit of the appended claims.

1. A composite product for use in manufacturing outdoor furniture, comprising:
a substrate core material;
a polyurethane foam, whereby said foam fully encapsulates said substrate core and provides a wood grain appearance, wherein said substrate core material is centrally positioned in said polyurethane foam; and
at least one fastener pin, wherein said at least one fastener pin securely attaches said substrate core material to a furniture frame.

2. The product of claim 1, wherein said product is manufactured using pentane as a blowing agent.

3. The product of claim 1, wherein said substrate core material is made of steel.

4. The product of claim 1, wherein said fastener pin is placed through said substrate core material prior to encapsulation with said polyurethane foam.

5. The product of claim 1, wherein said fastener pin is composed of a semi-rigid material.

6. An article of furniture manufactured using a composite product comprising a substrate core, polyurethane foam, and at least one fastener pin, whereby said foam fully encapsulates said substrate core and provides a wood grain appearance, wherein said substrate core is centrally positioned in said foam, and wherein said at least one fastener pin securely attaches said substrate core to a furniture frame.

7. The article of claim 6, wherein said product is manufactured using pentane as a blowing agent.

8. The article of claim 6, wherein said substrate core is made of steel.

9. The article of claim 6, wherein said product can be reinforced with center supports.

10. The article of claim 6, wherein said fastener pin is placed through said substrate core prior to encapsulation with said polyurethane foam.

11. A composite product, made with pentane as a blowing agent, for use in manufacturing outdoor furniture, comprising:
a substrate core, whereby said substrate core is made of steel;
polyurethane foam, whereby said foam fully encapsulates said substrate core and provides a wood grain appearance, wherein said substrate core is centrally positioned in said polyurethane foam; and
at least one fastener pin composed of semi-rigid material, wherein said at least one fastener pin attaches said substrate core to a furniture frame.

12. The product of claim 11, wherein said at least one fastener pin is placed through said substrate core prior to encapsulation with said polyurethane foam.
